(19) United States
(12) Patent Application Publication
(10) Pub. No.: US 2010/0088961 A1
(43) Pub. Date: Apr. 15, 2010

(54) Sectional door with mid-aspect opening capability

(76) Inventor: Jack Roten, Park City, UT (US)

Correspondence Address: Jack Roten, 3717 Sunridge Drive, Park City, UT, 84098, US

(21) Appl. No.: 12/288,126

(22) Filed: Oct. 15, 2008

(51) Int. Cl. E05D 15/22; E06B 3/50; E05D 5/02

(52) U.S. Cl. 49/209; 49/506; 16/387

(57) ABSTRACT

The present invention is directed generically to a closure for a portal within a structure, and more specifically, to a closure such as a sectional-type door, comprising plural door panels wherein one or more door panels can be operated independently of the remaining door panels and thereby the ingress point may be only partially occluded. Presently, sectional-type doors are used to block ingress/egress into permanent structures such as commercial and residential garages, and on a reduced scale, to block ingress/egress into mobile structures such as panel vans and storage containers. Heretofore, sectional-type doors have typically been employed wherein the sectional door traverse tracks located on either side of a portal as a linked series of door panels. Due to the means by which the series of door panels are linked, a sectional-type door may only be in one of three states relative to the portal opening: fully closed to a lower aspect, fully open to an upper aspect, and partially open wherein the sectional-type door depends from an upper aspect and thereby providing an unoccluded gap in the lower aspect. By modifying the means by which an individual door panel is linked to neighboring panels, it possible to independently operate one or more sectional-type door panels and thereby provide an opening in a portal occluded by a sectional-type door wherein a lower aspect of the portal opening is occluded and an opening is provided above the lower aspect and below the upper aspect.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Various structures, of both permanent and mobile nature, include a portal by which ingress and egress from an area confined therein is affected by use of a door. The door can be in many forms, including designs that use two or more subelements, which engage upon one another to occlude the portal. A particularly preferred door design includes use of a plurality of sub-elements in the form of door panels, each having a respective upper and lower long horizontal dimension and two opposing short vertical dimensions, all of which are interconnected to form a rectilinear shape with a thickness. The door panels are sequentially interlinked by one or more hinge elements along at least one horizontal edge such that the door panel sections operate collectively to block or otherwise occlude a portal. The door panels typically further include at least one rotating wheel on both vertical edges; rotating wheels, which are at least partially captured within a continuous track located opposite and equidistant from one another and on either side of the vertical axis of the portal. By having plural door panels, linked together by their respective horizontal axis, and moveable through the action of the rotating wheels along respective vertical edges, a sectional-type door can be readily operated to effectively occlude a portal while requiring a small amount of installation and operation space.

Sectional-type doors are capable of obtaining only one of three positions relative to a portal. A first position is where the interlinked sectional door panels are traversed to the furthest point relative to the continuous track such that the door is then in a “fully down” state and by the door being at a lowest aspect of the portal, the portal is fully occluded. A second position obtainable by a sectional-type door is where the interlinked sectional door panels are traversed to the closest point relative to the continuous track such that the door is then in a “fully up” state and by the door being at an upper aspect of the portal, the portal is completely unoccluded. The final position obtainable by a sectional-type door is where the interlinked sectional door panels are traversed to a point in between the fully down and fully up states. When a conventional sectional-type door is in at a point between the fully down and fully up states, by the nature of the interlinked door panels, the sectional-type door will depend from the upper aspect of the portal to a point above the lower aspect such that a gap exists between a lower most interlinked door panel and the lowest aspect achievable.

When sectional-type doors are employed as control points for a portal, there exists circumstances wherein it is desirable to have the sectional-type door partially open. Temperature control, accessing ventilation to exterior air sources, and visual inspection of interior spaces are routine issues which arise and in which a sectional-type door will be moved to a partial occlusion state. Due to the aforementioned nature of conventional sectional-type doors allowing for only partial occlusion in the lower region or aspect of a portal, such an opening is not conducive to remedying issues at hand; difficulty in venting high temperatures through a venting source located at point below the region of high temperature, hindrance of circulation by objects located on the ground or proximal to a lower opening, and difficulty in observing though a edifice significantly below eye level.

To remedy the deficiencies in conventional sectional-type door use in addressing issues of convenient access, numerous modification have been incorporated into the design of one or more of the panels of a sectional door. U.S. Pat. No. 3,927,709 to Anderson, et al. address ventilation control by modifying an upper door panel such that it can cam about an axis out of the vertical plane of the sectional door through interaction with a secondary continuous track segment. U.S. Pat. No. 4,141,403 to Church teaches to the use of sash-type window panes inserted into the construction of a sectional door panel, wherein the individual panes may be opened. U.S. Pat. No. 4,537,237 to Sepulveda, et al. incorporates a further set of pivots and hinges in the construction of panel interlinks such that one or more of the panels can be me louvered out of the vertical plane of the sectional-type door.

In related prior art, alternative means for allowing displacement of an individual door panel relatively to interlinked neighboring panels has focused specifically on controlling damage from impact. U.S. Pat. No. 5,720,332 to Nachreiner teaches to a panel, which can be deflected out of the vertical plane of the sectional door through rotation of the panel out of the continuous track. U.S. Pat. No. 5,535,805 to Kellogg et al. and U.S. Pat. No. 5,584,333 to Torchetti, et al. each address avoiding panel damage by allowing variations of a spring-biased track wheel to compress or deflect and thereby releasably disengage the continuous track until such point the track wheel is reinserted into the track.

Finally, the prior art has looked at easing installation of individual door panels to produce a sectional-type door assembly. U.S. Pat. No. 4,532,973 to DeFalco utilizes male and female profiled elements which are interdigitated as subsequent door panels are loaded into the continuous track and a sleeve element is inserted to prevent release of the door panels from the final assembly. U.S. Pat. No. 6,883,578 to Whitely utilizes a method of readily connecting subsequent door panels into a sectional-type door assembly by use of a one-way hinge element which allows for a “snap in place” fixture. U.S. Pat. No. 6,955,206 to Mullet, et al. incorporates hooks that engage into one another and are fixed in place by insertion of an interlock element.

There remains an unmet need for a means for allowing a sectional-type door to open in a region conducive to incremental functionality which does not require a door panel, or an aspect thereof, to displace outside the vertical plane of the door assembly, is readily actuated to allow for selective mid-aspect opening and closing of such a region, and is readily adapted to new and existing sectional-type door assemblies.

### SUMMARY OF THE INVENTION

The present invention is directed generically to a closure for a portal within a structure, and more specifically, to a closure such as a sectional-type door, comprising plural door panels wherein one or more door panels can be operated independently of the remaining door panels and thereby the ingress point may be only partially occluded. Presently, sectional-type doors are used to block ingress/egress into permanent structures such as commercial and residential garages, and on a reduced scale, to block ingress/egress into mobile structures such as panel vans and storage containers. Heretofore, sectional-type doors have typically been employed wherein the sectional door traverse tracks located on either side of a portal as a linked series of door panels. Due to the means by which the series of door panels are linked, a sectional-type door may only be in one of three states relative to the portal opening: fully closed to a lower aspect, fully open to an upper aspect, and partially open wherein the sectional-type door depends from an upper aspect and thereby providing an unoccluded gap in the lower aspect. By modifying the means by which an individual door panel is linked to neighboring panels, it is possible to independently operate one or more sectional-type door panels and thereby provide an opening in a portal occluded by a sectional-type door wherein a lower aspect of the portal opening is occluded and an opening is provided at a mid-aspect point, above the lower aspect and below the upper aspect.

A first preferred embodiment of the present invention is directed to a sectional-type door wherein at least one door panel within the sectional-type door assembly can be disengaged from one or more neighboring door panels. Upon disengaging a door panel from a neighboring panel, the construction allows for the creation of a partial occlusion across a portal. This partial occlusion can be located at an operative height above the effective height of at least one door panel positioned in the lower aspect of the portal opening and below a door panel positioned in the upper aspect of the portal opening. Further, the partial occlusion is formed within the vertical plane of the sectional-type door such that no incremental space is required for effective partial occlusion formation than that required by the sectional-type door itself.

A further embodiment of the present invention is directed to a sectional-type door wherein at least two door panels within the sectional-type door assembly can be disengaged from one or more neighboring door panels. Upon disengaging a door panel from a neighboring panel allows for the creation of a partial occlusion across a portal. This partial occlusion can be located at a first operative height above the effective height of at least one door panel positioned in the lower aspect of the portal opening and below door panel positioned in the upper aspect of the portal opening. The first operative height can then be adjusted to a second operative height by resetting the engagement of the first panel and disengaging the same or different door panel at a second location. Further, the partial occlusion is formed within the vertical plane of the sectional-type door such that no incremental space is required for effective partial occlusion formation than that required by the sectional-type door itself.

A further embodiment of the present invention is directed to representative means for effecting disengagement of at least one door panel from a neighboring or sequential door panel. The representative means allows for the ready disengagement of a hinge point such that the hinge point separates into an upper and lower element. The upper and lower elements may then be readily re-engaged such that the normal hinge operation is returned.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The invention will be more easily understood by a detailed explanation of the invention including drawings. Accordingly, drawings, which are particularly suited for explaining the inventions, are attached herewith; however, it should be understood that such drawings are for descriptive purposes only and as thus are not necessarily to scale beyond the measurements provided. The drawings are briefly described as follows:

FIG. 1 is a frontal view of a representative disengagable hinge assembly having a manually operated translatable axle (herein shown in a delinked position);

FIG. 2 is a cross sectional view of FIG. 1 taken along line II-II wherein a common axis of rotation is depicted between upper and lower hinge elements;

FIG. 3a is back-side view of two partial door panels linked by a representative disengagable hinge assembly, wherein the hinge elements are linked and the door panels operate in a sequential articulated manner;

FIG. 3b is a back-side view of two partial door panels linked by a representative disengagable hinge assembly, wherein a translatable axle has been slidably released from the axis of rotation between an upper and lower hinge elements;

FIG. 3c is a back-side view of two partial door panels linked by a representative disengagable hinge assembly, wherein the upper and lower hinge elements have been delinked at the axis or rotation such that an upper door panel can operate independently from a lower door panel and thereby create a partial occlusion space;

FIG. 4 is a frontal view of a representative disengagable hinge assembly having a manually operated translatable axle, herein shown in a delinked position, further including rotating track follower assemblies independently associated with each of the upper and lower hinge elements;

FIG. 5 is a frontal view of a representative disengagable hinge assembly having a manually operated translatable axle herein shown in a delinked position, further including remote cable actuation and an associated biasing means to return the translatable axle to a linked position;

FIG. 6a is a frontal view of a representative disengagable hinge on the left and right side of a portal with manually operated translatable axles herein shown in a delinked position, wherein the translatable axles of the left and right side disengagable hinge assemblies are operated by a common actuator;

FIG. 6b is a frontal view of a representative disengagable hinge on the left and right side of a portal with manually operated translatable axles herein shown in a linked position, wherein the translatable axles of the left and right side disengagable hinge assemblies are operated by a common actuator;

FIG. 7a is a frontal view of a representative disengagable hinge wherein the upper and lower hinge plates include a equal number of hinge pivots respectively;

FIG. 7b is a frontal view of a representative disengagable hinge wherein the lower hinge plate includes incrementally high number of hinge pivots relative to the upper hinge plate; and,

FIG. 7c is a frontal view of a representative disengagable hinge wherein the lower hinge plate includes hinge pivots bracketed by hinge pivots of the upper hinge plate.

### LIST OF REFERENCE NUMERALS

With regard to reference numerals used, the following numbering are applied throughout the drawings: disengagable hinge assembly 10, upper hinge plate 12, upper hinge plate mounting holes 13, upper hinge plate reinforcement 14, upper hinge left-side pivot 15, upper hinge right-side pivot 16, actuation handle 20, external actuation rod 22, actuation rod guide 24, internal actuation rod 26, translatable axle 28, guide mount 30, guide rails 32, actuator housing 34, actuator biasing means 38, lower hinge plate 42, lower hinge plate mounting holes 43, lower hinge plate reinforcement 44, lower hinge left-side pivot 45, lower hinge right side pivot 46, track follower mounting assembly 48, track follower assembly 50, upper track follower assembly 52, lower track follower assembly 54, upper sectional door panel 60, lower sectional door panel 70, common actuator handle 80, and common actuator 82.

### DETAILED DESCRIPTION OF THE INVENTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

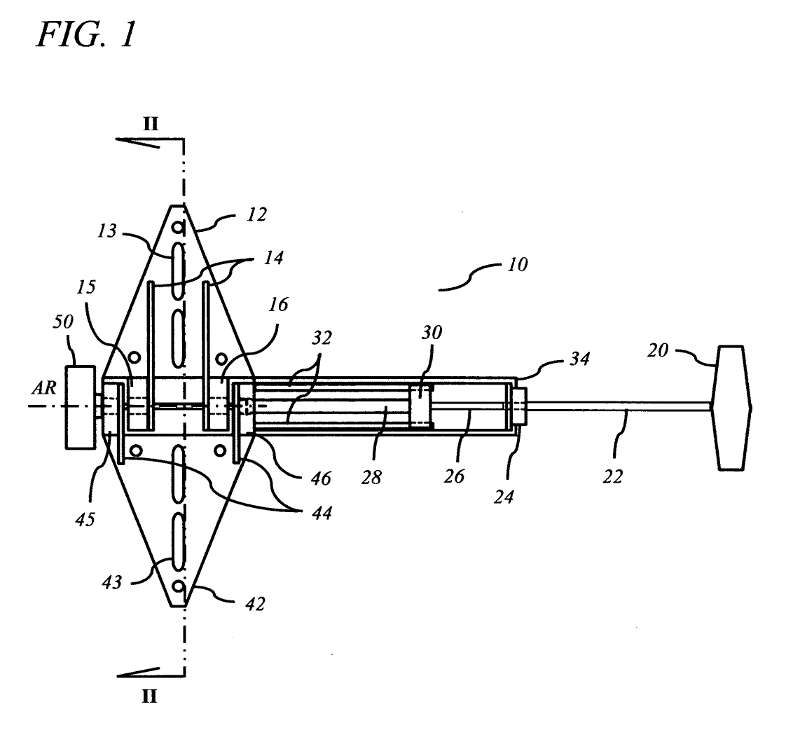

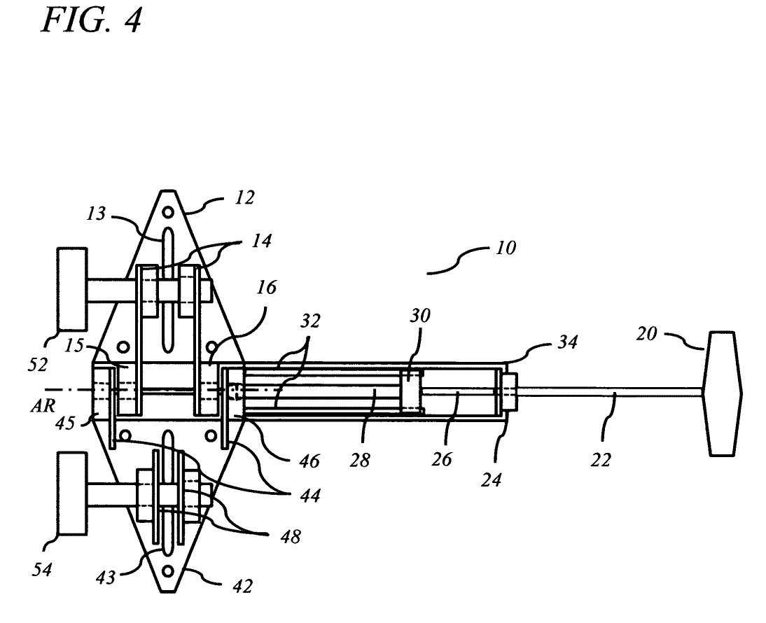

FIGS. 1 through 7 illustrate the present invention. FIG. 1 depicts an embodiment of the present invention wherein the primary goal of achieving mid-aspect opening in a sectional-type door is obtained. In FIG. 1, a complete disengagable hinge assembly 10 is shown, comprising an upper hinge plate 12, a lower hinge plate 42, and actuator housing 34. A track follower assembly 50 is shown associated with lower hinge plate 42. It is within the purview of the present invention that an upper track follower assembly 52 and lower track follower assembly 54 can be associated with upper hinge plate 12 and lower hinge plate 42, respectively (Reference FIG. 4).

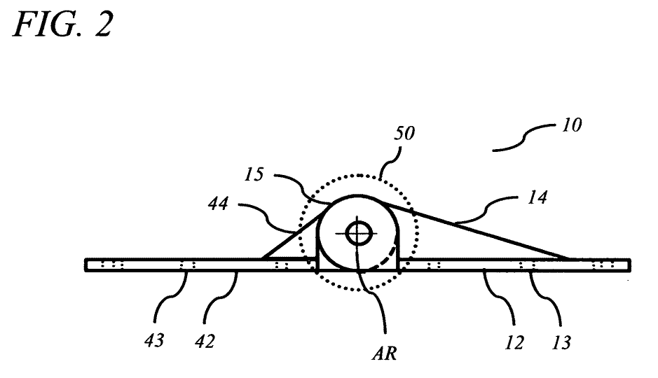

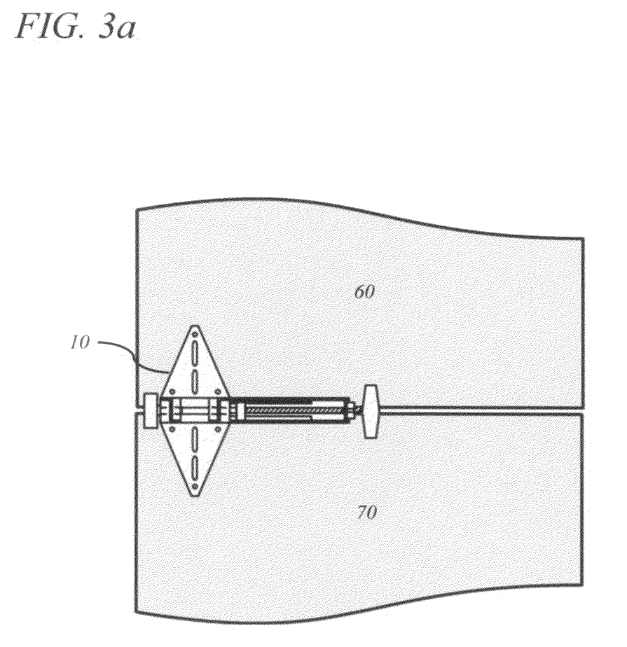

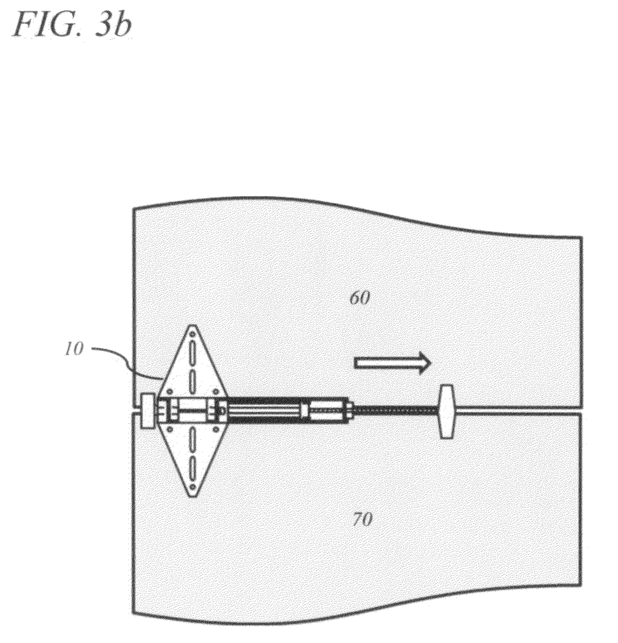

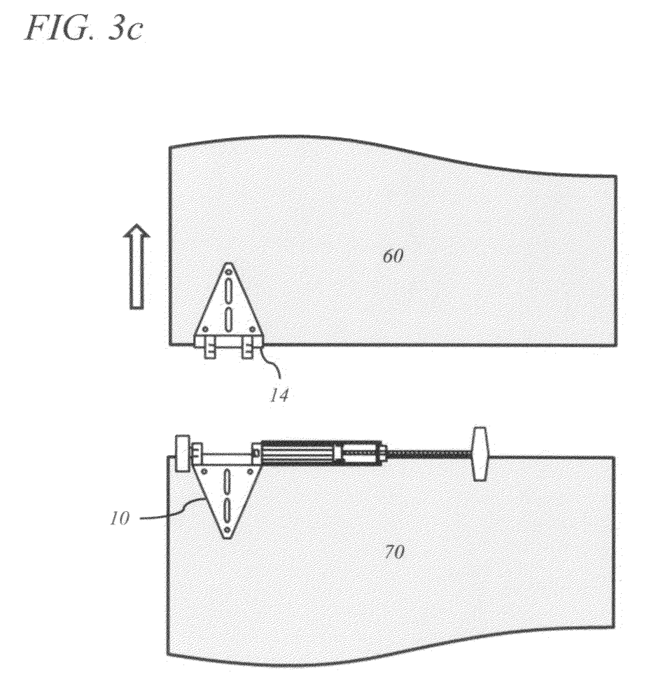

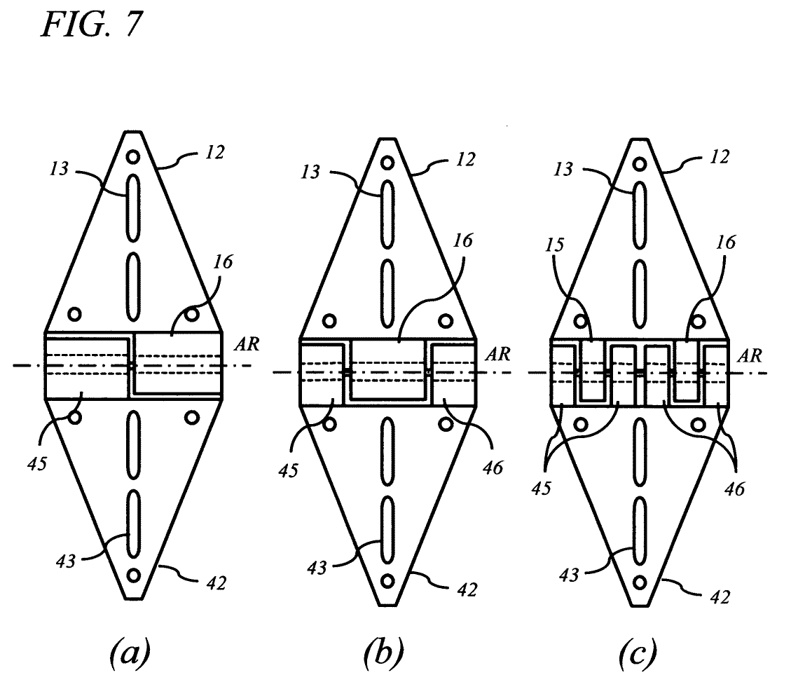

The upper hinge plate 12 (FIGS. 1 and 2) comprises optional upper hinge plate mounting holes 13, and at least one upper hinge pivot (Reference FIG. 7a) in the form of upper hinge plate left-side pivot 15 and/or upper hinge right-side pivot 16. Upper hinge plate 12 may optionally include one or more upper hinge plate reinforcement 14. Upper hinge plate reinforcement 14 may be any suitable integral or additional element which is durably integrated (i.e. bent, folded, welded, chemically adhered, bolted, and/or riveted) into upper hinge plate 12 so as to improve the torsional or flexural rigidity of upper hinge plate 12 assembly as it is employed in the static and dynamic operation of an associated sectional-type door. Particularly preferred upper hinge plate reinforcement 14 include use of angles of at least 5 degrees imparted into one or more regions of the upper hinge plate 12 and application of gusseting between the upper hinge plate 12 and upper hinge plate left-side pivot 15 and/or upper hinge plate right-side pivot 16. A plurality of through-holes in the form of upper hinge plate mounting holes 13 may be provided for mechanical attachment of the upper hinge plate 12 assembly to a door panel of a sectional-type door (Reference FIG. 3[a-c]) as part of either a new door panel fabrication or retrofitting to an existing section-type door installation. The shape, number, and positioning of upper hinge plate mounting holes 13 are not a limitation to the present invention so long as the holes are pre-positioned or are subsequently formed to allow for mechanical attachment of the upper hinge plate 12 assembly to a sectional-type door panel.

The lower hinge plate 42 comprises optional lower hinge plate mounting holes 43, and at least one lower hinge pivot (Reference FIG. 7a) in the form of lower hinge plate left-side pivot 45 and/or lower hinge right-side pivot 46. Lower hinge plate 42 may optionally include one or more lower hinge plate reinforcement 44. Lower hinge plate reinforcement 44 may be any suitable integral or additional element which is durably integrated (i.e. bent, folded, welded, chemically adhered, bolted, and/or riveted) into lower hinge plate 42 so as to improve the torsional or flexural rigidity of lower hinge plate 42 assembly as it is employed in the static and dynamic operation of an associated sectional-type door. Particularly preferred lower hinge plate reinforcement 44 include use of angles of at least 5 degrees imparted into one or more regions of the lower hinge plate 42 and application of gusseting between the lower hinge plate 42 and lower hinge plate left-side pivot 45 and/or lower hinge plate right-side pivot 46. A plurality of through-holes in the form of lower hinge plate mounting holes 43 may be provided for mechanical attachment of the lower hinge plate 42 assembly to a door panel of a sectional-type door (Reference FIG. 3[a-c]) as part of either a new door panel fabrication or retrofitting to an existing section-type door installation. The shape, number, and positioning of lower hinge plate mounting holes 43 are not a limitation to the present invention so long as the holes are pre-positioned or are subsequently formed to allow for mechanical attachment of the lower hinge plate 42 assembly to a door panel.

Upper hinge plate 12 and lower hinge plate 42 each comprise at least one hinge pivot, which upon proper positioning of the upper hinge plate 12 to lower hinge plate 42 allow respective hinge pivots to share a common axis of rotation (“AR”). FIG. 1 shows a particular embodiment wherein upper hinge plate 12 comprises a left-side hinge pivot 15 and right-side hinge pivot 16. It should be noted that the use of “left” and “right” in the body of this application is in respect to identifying elements of the figure as drawn and offers no functional limitation to actual practice in the manufacture or use of the device. FIG. 7a offers an equally suitable alternative to pivot design wherein upper hinge plate 12 includes a single hinge pivot in the form of upper hinge right-side pivot 16 and lower hinge plate 42 includes a single hinge pivot in the form of lower hinge left-side pivot 45. FIG. 7b presents an alternate pivot positioning scheme wherein upper hinge plate 12 includes a single hinge pivot in the form of upper hinge right-side pivot 16 (shown in a mid-line position relative to upper hinge plate 12) and lower hinge plate 42 includes a two hinge pivots in the form of lower hinge left-side pivot 45 and lower hinge right-side pivot 46, wherein the lower hinge pivots position to either side, or bracket, the upper hinge pivot FIG. 7c presents yet a further alternate pivot positioning scheme wherein upper hinge plate 12 includes a plurality of hinge pivots in the form of upper hinge left-side pivot 15 and upper hinge right-side pivot 16 (shown in a mid-line position relative to upper hinge plate 12) and lower hinge plate 42 includes a plurality of hinge pivots in the form of lower hinge left-side pivots 45 and lower hinge right-side pivots 46. The present invention is not limited to the maximum number, or the relative number, of hinge pivots associated with a given hinge plate so long as at least one hinge pivot with an upper hinge plate shares a common axis of rotation (“AR”) with at least one hinge pivot of a lower hinge plate.

Returning to FIG. 1, actuator housing 34 is comprised of elements, which allow for the actuation of a translatable axle into the common axis of rotation defined by the respective hinge pivots of the upper hinge plate 12 and lower hinge plate 42 assemblies. As depicted herein, a translatable axle 28 is mounted into actuator housing such that the translatable axle 28 moves slidably in a linear fashion from a left most fully engaged position to a right most fully disengaged position. Actuator housing 34 is shown associated with lower hinge plate 42 such that the left side tip of the translatable axle 28 rests within the lower hinge right-side pivot 46 when the translatable axle is in a full disengaged position. The right side of translatable axle 28 is fixedly attached to guide mount 30. Guide mount 30 performs several functions, including but not limited to; maintaining translatable axle 28 in alignment with the common axis of rotation (AR) formed by the positioning of upper and lower hinge pivots, preventing translatable axle 28 from displacing away from actuator housing 34, and to provide a fixture point for an associated means of applying force to effect linear movement of the translatable axle 28. To further enhance alignment of the translatable axle 28 fixed attached to guide mount 30, guide mount 30 may optionally follow guide rails 32. Guide rails 32 may be of any suitable geometry which allows for guide mount 30 to effectively maintain alignment of the translatable axle 28 with the common axis of rotation (AR), and may further include elements or compounds which control or reduce the force necessary to effect linear movement of the assembly.

Actuation of guide mount 30 and associated translatable axle 28 is through force applied to internal actuation rod 26. Internal actuation rod 26 extends from a fixture point on guide mount 30 through an actuation rod guide 24. Actuation rod guide 24 allows for linear alignment between the internal actuation rod 26 and the guide mount and aids in ensuring a vector associated with the applied force is aligned ultimately with the translatable axle 28.

Internal actuation rod 26 is acted upon through mechanical linkage to external actuation rod 22. The mechanical linkage between external actuation rod 22 and internal actuation rod 26 may include such fitments as copending threads, interdigitated fixtures and direct attachment. It is within the purview of the present invention that external actuation rod 22 and internal actuation rod may define separate regions of a singular component rendering both functions. Further, it is also in the purview of the present invention that external actuation rod 22, internal actuation rod 26 and translatable axle 28 may define separate regions of a singular component rendering all related functions of the aforementioned elements.

As shown in FIG. 1, external actuation rod 22 terminates with an actuation handle 20. Actuation handle 20 is configured for manipulation by hand and suitably designed for apply manual force to both engage and disengage the translatable axle 28 with the common axis of rotation (AR) defined by positioning of upper and lower hinge pivots. The disengagable hinge assembly 10 as show in FIG. 1 can be employed as a singular operating unit (as depicted in FIG. 3[a-c]). A plurality of disengagable hinge assembly 10 are typically employed at each link point along the horizontal aspect of two meeting door panels in a sectional-type door. Upon manual disengagement of the actuator assembly contained within actuator housing 34 for each of said plurality of disengagable hinge assemblies 10, the respective upper hinge plate 12 assembly is released from said lower hinge plate assembly 42. At this point, an upper door panel with one or more disengaged upper hinge plate 12 assemblies can operate independent of a previously linked lower door panel; the lower door panel retaining one or more disengaged lower hinge plate 42 assemblies. Thus, a lower door panel (and any associated engaged door panels associated subsequent thereto) can be positioned to occlude a lower aspect of a portal. Likewise, an upper door panel (and any associated engaged door panels associated previous thereto) can be retracted towards the upper aspect of a portal by way of the associated continuous track to thereby create an opening in a mid-aspect of a portal and maintaining the vertical plane of the sectional-type door without intruding or otherwise extending beyond the space required for the door. The process is easily reversed by returning the upper door panel with the associated upper hinge plates 12 to a position of common axis of rotation with the lower hinge plates 42 associated with the lower door panel and manually actuated the translatable axle 28 to an engaged position.

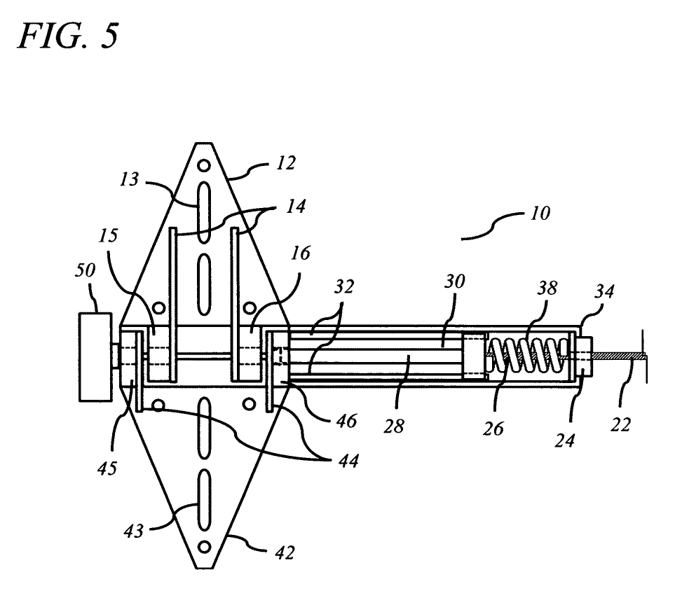

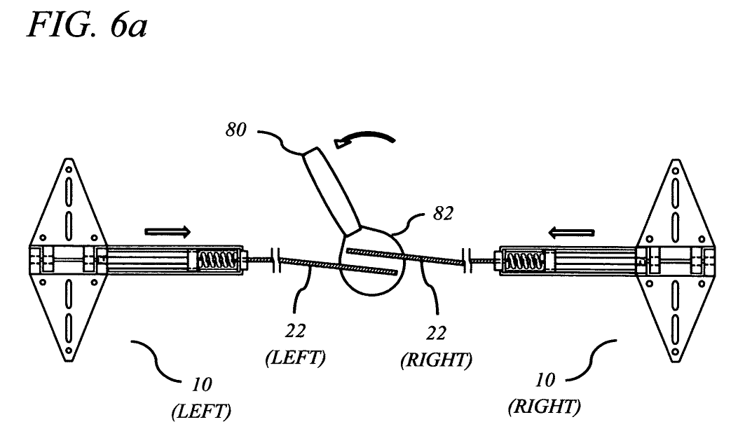

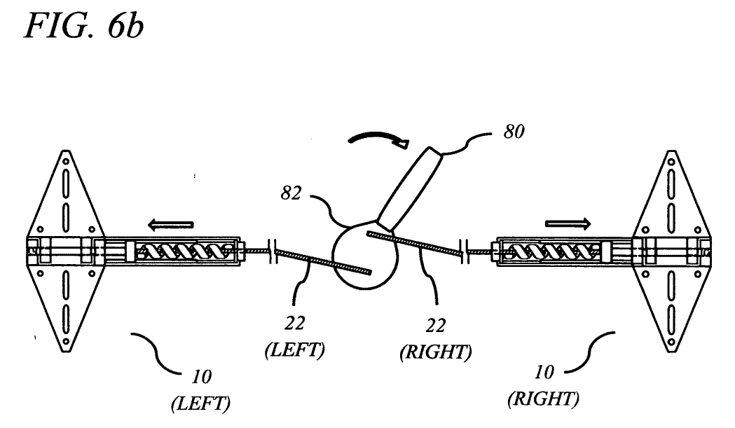

The presently described disengagable hinge assembly 10 can also be connected to one or more additional disengagable hinge assembly 10 such that operation of a single actuator will cause multiple such assemblies to engage or disengage. FIG. 5 depicts a modified disengagable hinge assembly 10 wherein a suitable actuator biasing means 38 (i.e. helical spring) has been superimposed about internal actuator rod 26. Actuator biasing means 38 acts upon guide mount 30 to preferentially maintain the associated translatable axle 28 in an engaged position through the common axis of rotation defined by upper and lower hinge pivots. Further, external actuator rod 22 has optionally been replaced with a flexible cord wherein the flexible cord exhibits a low coefficient of elongation. Utilizing the modified disengagable hinge assembly 10 from FIGS. 5, 6a and 6b show application of two such assemblies operated by a single common actuator 82. Common actuator 82 allows for the simultaneous engagement and disengagement of left and right depicted disengagable hinge assemblies. By rotating common actuator handle 80, common actuator 82 causes the translatable axle 28 in each assembly to move into or out of registry or alignment with the common axis of rotation defined by the upper and lower hinge pivots in the respective assembly.

The means of applying force to the actuator rods 22 and 26, and thereby to engage or disengage translatable axle 28 can range from manual, to semi-automatic, to completely automatic operation. Any suitable means for applying a force to the actuation rod can be employed. Ball and screw, rack and pinion, and piston/solenoid actuation mechanisms can be manually operated or motivated by a motor, pneumatic, hydraulic or direct electrical power source.

The components comprising disengagable hinge assembly 10 described heretofore may be formed by conventional manufacturing means and of suitable base materials. By way of description, manufacturing processes including rolling, stamping, casting, forging, and extrusion technologies are appropriate technologies for fabricating one or more of the listed components. Suitable materials for individual components include ferrous metals, non-ferrous metals, polymers, modified polymers and the laminates, composites and other combinations thereof. Exemplary ferrous metals include galvanized steel, mild steel, tool steel and stainless steel. Nonferrous metal may include aluminum, tin, bronze, copper and alloys thereof. Polymers include thermoplastic, thermoset, naturally derived compositions and combinations thereof. Modified polymers include previously mentioned polymers further comprising performance modifying (i.e. polymer alloys, fiber reinforcement) and aesthetic modifying (i.e. colorants, pigments and lubricous agents) additives.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A sectional-type door comprising;
a. a first door panel having an upper and a lower horizontal dimension and two opposing vertical dimensions connecting said upper and lower horizontal dimension;
b. a second door panel having an upper and a lower horizontal dimension and two opposing vertical dimensions connecting said upper and lower horizontal dimension;
c. a first and second continuous track defining a common path of movement located opposite and equidistant to one another, wherein a vertical plane is defined between said first and said second continuous tracks;
d. a track follower assembly which allows for movement through said path of said continuous tracks;
e. a hinge assembly which pivots about a common axis of rotation and which upon activation allows for said hinge assembly to disengage from itself;
wherein said first door panel has at least one track follower assembly affixed on each vertical dimension thereof;
wherein said second door panel has at least one track follower assembly affixed on each vertical dimension thereof;
wherein said track follower assemblies of said first panel are engaged into said continuous tracks and said track follower assemblies of said second panel are engaged into said continuous tracks such that said first panel is positioned above said second panel;
wherein at least one of said disengagable hinge assembly is affixed along said horizontal dimension between said upper first door panel and said lower second door panel such that said first door panel and said second door panel operate as a single unit through said continuous tracks; and
whereupon activation of said hinge assembly, said upper first door panel and said lower second door panel operate as independent units from one another.

2. A sectional-type door as in claim 1, wherein said sectional-type door variably occludes a portal.

3. A sectional-type door as in claim 2, wherein said first door panel occludes an upper aspect of said portal.

4. A sectional-type door as in claim 2, wherein said second door panel occludes a lower aspect of said portal.

5. A sectional-type door as in claim 2, whereupon activation of said hinge assembly an opening is formed in a mid-aspect of said portal.

6. A sectional-type door as in claim 5, whereupon activation of said hinge assembly an opening is formed in a mid-aspect of said portal wherein said first door panel and said second door panel remain in said vertical plane.

7. A method for forming an opening in a sectional-type door to a portal comprising;
a. obtaining a sectional-type door comprising at least two sequential door panels operable through a path defined by two opposing continuous tracks to form a vertical plane;
b. positioning said sectional-type door proximal to a portal;
c. affixing one or more disengagable hinge assemblies along a common axis of rotation between said first door panel and said second door panel;
d. activating said disengagable hinge assemblies so as to allow said hinge to disengage from itself; and
whereupon activation of said hinge assembly, said upper first door panel and said lower second door panel operate as independent units from one another.

8. A sectional-type door as in claim 7, wherein said first door panel occludes an upper aspect of said portal.

9. A sectional-type door as in claim 2, wherein said second door panel occludes a lower aspect of said portal.

10. A sectional-type door as in claim 2, whereupon activation of said hinge assembly an opening is formed in a mid-aspect of said portal.

11. A sectional-type door as in claim 5, whereupon activation of said hinge assembly an opening is formed in a mid-aspect of said portal wherein said first door panel and said second door panel remain in said vertical plane.

12. A disengagable hinge assembly for a sectional-type door comprising;
a. an upper hinge plate having at least one upper hinge pivot and said upper hinge plate is affixed to a first door panel;
b. a lower hinge plate having at least one lower hinge pivot and said upper hinge plate is affixed to a second door panel;
c. a translatable axle;
wherein said upper hinge pivot and said lower hinge pivot form a common axis of rotation when aligned;
wherein fitment of said translatable axle through said common axis of rotation of said upper hinge pivot and said lower hinge pivot forms a hinge assembly which can pivot about said common axis of rotation, thus allowing said first door panel to operate with said second door panel as a singular unit; and
wherein removal of said translatable axle from said common axis of rotation of said upper hinge pivot and said lower hinge pivot allows for said hinge assembly to disengage from itself, thus allowing said first door panel and said second door panel to operate independent of one another.

13. A disengagable hinge assembly as in claim 12, wherein said upper hinge plate includes two or more upper hinge pivots.

14. A disengagable hinge assembly as in claim 12, wherein said lower hinge plate includes two or more lower hinge pivots.

15. A disengagable hinge assembly as in claim 12, wherein said translatable axle is motivated by an actuator.

16. A disengagable hinge assembly as in claim 15, wherein said actuator is manually operated.

17. A disengagable hinge assembly as in claim 15, wherein said actuator is electrically operated.

18. A disengagable hinge assembly as in claim 15, wherein said actuator is joined to a common actuator.

19. A disengagable hinge assembly as in claim 15, wherein said actuator includes a biasing means.
